(19) United States
(12) Patent Application Publication
(10) Pub. No.: US 2006/0008080 A1
(43) Pub. Date: Jan. 12, 2006

(54) Modular-multiplication computing unit and information processing unit

(75) Inventors: Kunihiko Higashi, Kawasaki-shi (JP); Toru Hisakado, Kawasaki-shi (JP); Satoshi Goto, Kitakyushu-shi (JP); Takeshi Ikenaga, Kitakyushu-shi (JP)

Correspondence Address: SUGHRUE MION, PLLC, 2100 PENNSYLVANIA AVENUE, N.W., SUITE 800, WASHINGTON, DC, 20037, US

(73) Assignees: NEC ELECTRONICS CORPORATION; WASEDA UNIVERSITY

(21) Appl. No.: 11/176,209

(22) Filed: Jul. 8, 2005

(30) Foreign Application Priority Data
Jul. 9, 2004 (JP) 2004-203436

(51) Int. Cl. H04K 1/00

(52) U.S. Cl. 380/28

(57) ABSTRACT

The bit strings of multipliers B and N are converted through the use of the Booth's algorithm in units composed of a predetermined number of bits and the operation of A×B+u×N is executed by a carry save adder using the value of an integral multiple of multiplicand A corresponding to the multiplication result of the values of the converted multiplier B and multiplicand A and also the value of an integral multiple of multiplicand u corresponding to the multiplication result of the values of the converted multiplier N and multiplicand u. The operation result of A×B+u×N supplied from the carry save adder are added to the operation result in the past of A×B+u×N through the use of an adder and the added result is supplied as the result of a modular-multiplication operation S=S+A×B+u×N.

### BACKGROUND OF THE INVENTION

1. Field of Invention

The present invention relates to a modular-multiplication computing unit for efficiently implementing a modular exponentiation operation and an information processing unit having the same.

2. Description of the Related Art

Recent dramatic progress in the processing capabilities of a variety of information processing devices, for example, personal computers, PDA (Personal Digital (Data) Assistants), mobile phones, etc. and further, recent advances in improving the capacities of a variety of recording media and advances in the provision of communication infrastructure have been increasing the occasions in which personal information, business information, etc. communicate through networks and radio means. Consequently, technology for maintaining the secrecy of information and preventing leakage to third parties has become more important.

As general means to keep secret communication data, the common key cryptosystem is known as general means to ensure the secrecy of data communications according to which terminal devices that communicate data with each other employ a common key for encrypting and decrypting the data. With the wide spread of electronic commercial transactions such as B-to-B (Business to Business), B-to-C (Business to Consumer), etc., PKI (Public Key Infrastructure) technology has been the subject of considerable focus.

The public key cryptosystem, which is a basic technology of PKI, is a cryptosystem in which transmitted data is encrypted through the use of a public key and received data is decrypted through the use of a private or secret key, which is paired with the public key and not made public. In this public key cryptosystem, the transmission side and the reception side have different keys and it is not necessary to show the private key to the communication partner. Accordingly, the performance of the public key cryptosystem has greater credibility than common key cryptosystems.

In the public key cryptosystem, the RSA (Rivest, Shamir and Adleman) code is mainly used at present (cf. Masaaki Mitani: “Industrial Mathematics For Fresh Start”, The fifth edition, CQ Press, Feb. 1, 2003, pp. 115-122). The RSA code is a cryptosystem that utilizes the difficulty in the factorization into prime factors of the number N, which is a product of two arbitrary prime numbers, and also utilizes various different features of an algebraic number modular N. Modular exponentiation operations (M^{d} mod N) are implemented for encryption and decryption.

A modular exponentiation operation is commonly implemented by being replaced with the repeated operations of the modular-multiplication operation described below: Let, for example, d=19. Then, from d=1+2×(1+2×(0+2×(0+2×1))),

$$C = {M}^{d} mod N \\ = {M}^{1 + 2 \times ( 1 + 2 \times ( 0 + 2 \times ( 0 + 2 \times 1 ) ) )} mod N \\ = {( {( {( {( {M}^{1} )}^{2} {M}^{0} )}^{2} {M}^{0} )}^{2} {M}^{1} )}^{2} {M}^{1} mod N \\ = {( {( {( {M}^{2} )}^{2} )}^{2} M )}^{2} M mod N .$$

The decomposition of d as described above enables reduction in the operation number as compared to simply multiplying M d times, thereby reducing operation time. For reference, there are a variety of known methods for decomposing d, and the above-described approach is one example of such a method.

The modular-multiplication operation as described above, however, is very difficult to execute efficiently regardless of whether hardware or software is utilized, because the multiplication operation yields a double digit number of calculations and further the multiplication result must be divided by N. For this reason, a variety of approaches have been studied up to now to compute the modular multiplication operation more efficiently. As a typical example, there is known a computation method based on the algorithm called the Montgomery method (cf. for example, JP 2001-527673).

Application of the Montgomery method enables achieving the modular multiplication operation by multiplication and arithmetic addition and subtraction without substantial division. The modular multiplication operation P(AB)_{N}=AB×r⁻ⁿ mod N=S can be achieved according to the procedures, for example, shown in (1) to (8) below, wherein 0≦N<rⁿ, N is an odd number (the N and r are relatively prime to each other), 0≦A<N, 0≦B<N and A=Aₙ₋₁Aₙ₋₂ . . . . A₀ (for example, A₃A₂A₁A₀=1234).
(1) v=−N⁻¹ mod r,
(2) S=0,
(3) for i=0 to n−1 {
(4) S=S+Aᵢ×B
(5) u=S×v mod r
(6) S=S+u×N
(7) S=S/r
(8) }

The modular multiplication operation can be substituted for the repetitive operations of S=S+Aᵢ×B+u×N (i=0 to n−1) based on the above algorithm, and the modular-multiplication computing unit for achieving this process has a configuration, for example, shown in FIG. 1.

FIG. 1 is a block diagram illustrating the configuration of a conventional modular-multiplication computing unit.

As shown in FIG. 1, the conventional modular-multiplication computing unit has a configuration comprising: first latch circuit 51 that keeps the value of said A, which is a multiplicand; second latch circuit 52 that keeps the value of said u, which is a multiplicand; third latch circuit 53 that keeps the value of A+u; selector 57 that selects multiplicand A, u, A+u or OH (all bits equal 0) depending on the values of multipliers B and N supplied on a bit-by-bit basis and supplies the selected result; a well known carry save adder (referred to as CSA) 56 that computes A×B+u×N through the use of the output values of selector 57; and adder 59 that adds modular-multiplication operation result S, that is computed and externally stored, to modular-multiplication operation result S provided from CSA 56 and supplies the added result as a result of modular-multiplication operation S. For reference, the values of A, u and A+u are supplied to first to third latch circuits 51, 52 and 53, respectively, under control of, for example, a control unit (not shown), and the values of multipliers B, N and 0 H are supplied to selector 57 under control of, for example, a control unit (not shown).

In the modular-multiplication computing unit shown in FIG. 1, multipliers B and N that have the processing bit length of the modular-multiplication computing unit (for example, 512 bits) are provided to selector 57 on a bit-by-bit basis. Further, multiplicands A, u and A+u are stored in the respective latch circuits in a unit of the bit-length corresponding to the processing bit-length of CSA 56 (m bits in FIG. 1) and supplied to CSA 56. Consequently, if, for example, the processing bit length of the modular-multiplication computing unit is 512 bits and the processing bit length of CSA 56 is 128 bits, then the circuitry shown in FIG. 1 completes the operation of A (128 bits)×B (512 bits)+u (128 bits)×N (512 bits) by repeating the selection procedures of multiplicands A, u and A+u 512 times, and further by repeating those procedures (the operation of A (128 bits)×B (512 bits)+u (128 bits)×N (512 bits)) 4 times, the circuitry comes to complete the operation of A (512 bits)×B (512 bits)+u (512 bits)×N (512 bits).

Selector 57 selects one of multiplicands A, u, A+u and 0 H supplied from first to third latch circuits (51 to 53) depending on the values of multipliers B and N supplied on a bit-by-bit basis and provides the selected value to CAS 56. CAS 56 computes A×B+u×N by shift-adding multiplicands A, u and A+u and 0 H, successively supplied from selector 57, and while keeping the interim result, provides, as an output, the result of the modular multiplication operation S on a bit-by-bit basis.

In the public key cryptosystem, the RSA code is widely employed at present using the numerical values of 1024 bits for C, M, N and d in the above-described modular exponentiation operation and a further increase is expected in the number of bits. In order to execute the modular exponentiation operation for such an increased number of bits, an enormous amount of computation of modular multiplication operation for encryption and decryption must be undertaken. The public key cryptosystem is problematic in that it needs a long processing time for encryption and decryption as compared to the common key cryptosystem, and thus a key issue has been to reduce the operation time required for the modular multiplication operation.

In the conventional modular-multiplication computing unit as shown in FIG. 1, it is possible to reduce the number of the repetitive operations thereby reducing the operation time by elongating the processing bit lengths of, for example, the latch circuits that keep multiplicands and the CSA so as to increase the number of bits to be processed at one time. The elongation of the processing bit length of the CSA, however, involves increases in the bit lengths of the register, which keeps the interim result of the operation within the CSA, the latch circuit, which keeps a multiplicand, and the selector. This gives rise to the problem that the circuit size of the modular-multiplication computing unit will increase.

In this regard, with the widespread use of information-processing devices such as mobile phones, PDAs, personal computers, server devices, etc., the market requires products having high processing performance and low cost. Thus, in order to satisfy such requirements, it is fundamentally important to realize a modular-multiplication computing unit that allows not only reducing the operation time required for the modular multiplication operation but also reducing the circuit size.

### SUMMARY OF THE INVENTION

In view of the above problems, it is an object of the present invention to provide a modular-multiplication computing unit that allows further reduction of the operation time and also to provide an information processing unit with the same.

It is another object of the present invention to provide a modular-multiplication computing unit that allows reduction of the operation time without increasing circuit size and also to provide an information processing unit with the same.

In order to achieve the above objects, the present invention converts the bit strings of multipliers B and N through the use of the Booth's algorithm in units composed of a predetermined number of bits and executes the operation of A×B+u×N by the CSA using the value of an integral multiple of multiplicand A (for example, 0, +1A, +2A) corresponding to the multiplication result of the values of the converted multiplier B and multiplicand A and also using the value of an integral multiple of multiplicand u (for example, 0, ±1 u, ±2u) corresponding to the multiplication result of the values of the converted multiplier N and multiplicand u. The operation result of A×B+u×N supplied from the CSA are added to the previous operation result in the of A×B+u×N through the use of an adder and the added result is supplied as a result of a modular-multiplication operation S=S+A×B+u×N.

The above-described modular-multiplication computing unit and the information processing unit with the same allow processing the multipliers in units composed of a plurality of bits by adopting the Booth's algorithm at the CSA and thus enable reducing the processing bit length of the CSA, thereby reducing the operation time as compared to the conventional modular-multiplication computing unit. Further, the reduction of the processing bit length of the CSA enables significant reduction of the number of flip-flops provided in the CSA, thereby reducing the circuit size of the modular-multiplication computing unit.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram illustrating a construction of a conventional modular-multiplication computing unit.

FIG. 2 is a schematic diagram representing specific examples of converting a multiplier through the Booth's algorithm.

FIG. 3 is a block diagram representing a constructional example of the modular-multiplication computing unit of the present invention.

FIG. 4 is a block diagram representing a constructional example of the information processing unit of the present invention.

FIG. 5 is a graph showing the layout area of the modular-multiplication computing unit of the present invention.

FIG. 6 is a graph showing the number of the processing clocks in the modular-multiplication computing unit according to the present invention.

FIG. 7 is a graph showing the relation of the layout area to the number of the processing clocks in the modular-multiplication computing unit according to the present invention.

### DETAILED DESCRIPTION OF THE PREFERRED EMBODIMENT

Brief explanation is presented first regarding the Booth's algorithm that is utilized in the modular-multiplication computing unit according to the present invention. The Booth's algorithm is a technique in which the number of multiplication operations is reduced by using the complement representation of 2. For example, in suppose the operation A×011111, it is normal that five operations are required to compute A×011111=A×010000+A×001000+A×000100+A×000010+A×000001. However, if the above-described complement representation of 2 is alternatively applied, the multiplier 011111 can be represented as 100000−1 and hence the equality A×011111=A×(100000−1)=A×100000−A×000001 keeps. As a result, the required number of operations is only 2.

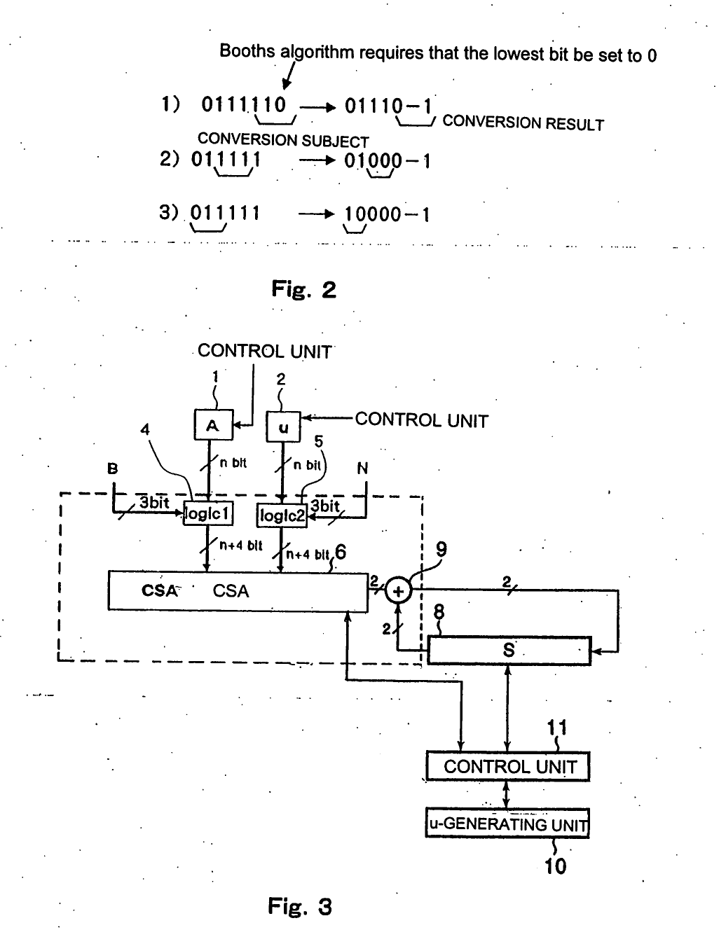

Booth's algorithm, in computing A×B, divides multiplier B into units composed of bits, for example, 2 bits+1 bit multiples=3 bits each and repeatedly implements partial multiplications by the divided multipliers B. Table 1 represnts the values of the partial products corresponding to the divided 3 bits. For reference, FIG. 2 shows a specific example of the case where multiplier 011111 is converted for every 2 bits (adding the 1 bit multiples totals 3 bits) using the Booth's algorithm.

TABLE 1
Radix 4: 0, 1, 2, 3 [symbol] 0, ±1, ±2

| | B[i + 1] | B[i] | B[i − 1] | Z[i + 1] | Z[i] | Remark |
|---|---|---|---|---|---|---|
| | 0 | 0 | 0 | 0 | 0 | 0 |
| 0 | 0 | 0 | 1 | 0 | 1 | A |
| | 0 | 1 | 0 | 0 | 1 | A |
| 1 | 0 | 1 | 1 | 1 | 0 | 2A |
| | 1 | 0 | 0 | −1 | 0 | −2A |
| 2 | 1 | 0 | 1 | 0 | −1 | −A |
| | 1 | 1 | 0 | 0 | −1 | −A |
| 3 | 1 | 1 | 1 | 0 | 0 | 0 |

B: Input values
Z: Output values

In the case of converting the multiplier for every 2 bits, the multiplier to be converted has one of the values 0, 1, 2 or 3 (the radix is 4). The multiplier, on the other hand, has one of the values of 0, +1, −1, +2 and −2 after the conversion through the use of Booth's algorithm, as shown in Table 1.

Accordingly, if the purpose is to implement a multiplication operation using the multiplier before the Booth's conversion (2 bits), it is necessary to prepare the values of 0 to 3 times the value of the multiplicand as the values corresponding to the result of the multiplication operation. For example, assuming that the multiplicand and multiplier are A and B, respectively, the value to be supplied to CSA is 0 if multiplier B is 0 (00), 1A if multiplier B is 1 (0,1), 2A if multiplier B is 2 (1,0) and 3A if multiplier B is 3 (1, 1). Thus, these values need to be provided beforehand. Of the above values, 0 and 1A are the values that necessitate no computing operation. The value 2A also basically does not require any computing operation, because the value 2A need only shift the value of each bit of the binary number 1A to the left by one bit and set 0 to the lowest bit. Regarding 3A, however, it is necessary needed to precompute the value of 1A+2A, or to supply the values of both 1A and 2A individually to the CSA.

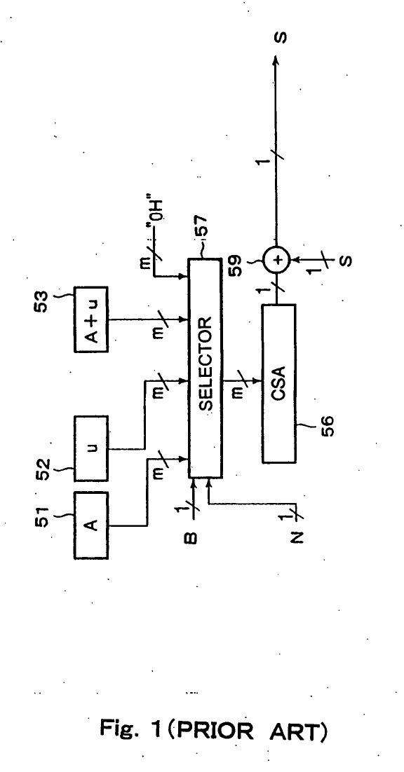

Such processing as this, because a multiplicand is multiplied by a multiplier in a 2-bit batch, also enables reducing the processing time as compared to the architecture (cf. FIG. 1) of the conventional modular-multiplication computing unit in which a multiplier is multiplied by a multiplicand bit by bit. The case of precomputing 1A+2A necessitates an adder for implementing the addition operation in advance, thus the circuit size increases. The case of supplying the values of both 1A and 2A individually to the CSA, on the other hand, causes an increase in the input data to the CSA, entailing the increase in the circuit size.

In the case where the multiplier is converted through the use of Booth's algorithm, in contrast, only one of 0, ±1, ±2 times the multiplicand, i.e., 0, ±1A, ±2A need be supplied to CSA. In this case, the values, 0, 1A and 2A, need not basically be computed as described above, thus they can be easily obtained. In this regard, the value of −1A (−2A) can be represented by inverting the value of 1A (2A) and adding 1. For this reason, a sign bit (1 bit) is required for −1A (−2A) to indicate that the number −1A (−2A) is a negative number.

The modular-multiplication computing unit of the present invention is designed such that the bit strings of multipliers B and N are each converted by means of the Booth's algorithm for every predetermined number of bits and A×B+u×N is computed by the CSA using both the value of the integral multiple of multiplicand A (for example, 0, 1A, 2A) corresponding to the multiplication result of the value of multiplier B after conversion by Booth's algorithm and multiplicand A, and the value of the integral multiple of multiplicand u (for example, 0, ±1 u, ±2u) corresponding to the multiplication result of the value of multiplier N after conversion by Booth's algorithm and multiplicand u.

FIG. 3 is a block diagram representing a construction example of the modular-multiplication computing unit of the present invention.

As shown in FIG. 3, the modular-multiplication computing unit of the present invention has: first latch circuit 1 that keeps the value of multiplicand A; second latch circuit 2 that keeps the value of multiplicand u; first logic circuit (logic1) 4 that provides the value of the integral multiple of multiplicand A (0, ±1A, ±2A) corresponding to the multiplication result of the value of multiplier B supplied in a batch composed of a plurality of bits (3 bits in FIG. 3) and multiplicand A; second logic circuit (logic2) 5 that provides the value of the integral multiple of multiplicand u (0, ±1 u, ±2u) corresponding to the multiplication result of the value of multiplier N supplied in a batch composed of a plurality of bits (3 bits in FIG. 3) and multiplicand u; well-known CSA 6 that implements the computation of A×B+u×N making use of the values supplied from first and second logic circuits 4, 5; first shift register 8 that keeps the result of modular-multiplication operation S supplied from CSA 6 in units composed of a plurality of bits (2 bits in FIG. 3) and supplies the kept result of modular-multiplication operation S in the order in which the result of modular-multiplication operation S has been kept; adder 9 that adds the operation result of A×B+u×N supplied from CSA 6 and the output of first shift register 8 and stores the added result in first shift register 8 again as a result of the modular-multiplication operation S; u-generating unit 10 that stores a table to generate the value of multiplicand u; and control unit 11 that operates to supply the values of multiplicands A and u to first and second latch circuits 1, 2, respectively, and to supply the values of multipliers B and N to first and second logic circuits 4, 5, respectively, and also controls the operations of CSA 6, first shift register 8 and u-generating unit 10.

The modular-multiplication computing unit according to the present invention operates in synchronization with an externally supplied clock signal (CK) of a predetermined frequency under by setting multiplicands A and u to the latch circuits and by setting multipliers B and N to first and second logic circuits 4 and 5, respectively, through control unit 11, wherein control unit 11 can be realized by, for example, a CPU, a DSP, logic circuits, or the like that runs a program.

In the modular-multiplication computing unit having the above circuitry according to the present invention, multiplicands A, u are each divided into a plurality of batches composed of bits corresponding to the processing bit length of CSA 6 and stored in first and second latch circuits 1, 2, respectively, in units composed of the divided bit batch under control of control unit 11. Further, multiplicand A is supplied from first latch circuit 1 to first logic circuit 4 in n-bit units corresponding to the processing bit length of CSA 6, and multiplicand u is supplied from second latch circuit 2 to second logic circuit 5 in n-bit units corresponding to the processing bit length of CSA 6. Multipliers B and N, on the other hand, are supplied in 3-bit units to first and second logic circuit 4, 5, respectively, from, for example, control unit 11.

In this regard, it is feasible that multipliers B and N are first stored in memory elements adapted to supply the stored data in units composed of a plurality of bits such as shift registers, RAM or the like and then supplied to first and second logic circuits 4 and 5 from the memory elements in units composed of a predetermined plurality of bits. In this case, multipliers B and N are stored in the memory elements under the control of control unit 11 in units composed of the processing bit length of the modular-multiplication computing unit, or in lengths made up of a plurality of bits created by dividing the processing bit length composed of the modular-multiplication computing unit into lengths of a plurality of bits.

While FIG. 3 illustrates an example in which multipliers B and N are supplied to first and second logic circuit 4 and 5, respectively, in 3-bit units (2 bits+1 bit multiples), the supply unit of multipliers B and N can be 4 or more bits. If the radix is 16, for example, then multipliers B and N are supplied to first and second logic circuits 4 and 5, respectively, in units of 5 bits (4 bits+1 bit multiples).

First logic circuit 4 creates ±1A, ±2A using the value of multiplicand A supplied from first latch circuit 1; converts multiplier B supplied by 3 bits in accordance with the Booth's algorithm; selects, from the converted result, one of 0, ±1A or ±2A corresponding to the multiplication result of multiplier B and multiplicand A; and supplies the selected result to CSA 6 in units of n+4 bits. Further, second logic circuit 5 creates ±1u, ±2u using the value of multiplicand u supplied from second latch circuit 2; converts multiplier N supplied by 3 bits in accordance with the Booth's algorithm; selects, from the converted result, one of 0, ±1 u or ±2u corresponding to the multiplication result of multiplier N and multiplicand u; and supplies the selected result to CSA 6 in units of n+4 bits. While FIG. 3 illustrates an example of selecting one of 0, ±1A or ±2A and one of 0, ±1u or ±2u through the use of the two logic circuits, any number of the logic circuits are allowable, provided that it is possible to select one of 0, ±1A or ±2A and one of 0, ±1u or ±2u corresponding to the values of multipliers B and N, respectively. Moreover, while FIG. 3 illustrates an example in which first and second logic circuits 4, 5 convert multipliers B and N, respectively, supplied by 3 bits by means of the Booth's algorithm, it is alternatively possible to design the modular-multiplication computing unit such that control unit 11 operates to supply the values to first and second logic circuits 4 and 5 after conversion by Booth's algorithm. In this embodiment, first logic circuit 4 is supplied with multiplier B in units of 2 bits after conversion by Booth's algorithm and second logic circuit 5 is supplied with multiplier N in units of 2 bits after conversion by Booth's algorithm.

Explanation below discusses the reasons why the selected values of the multiplicands provided from first and second logic circuits 4, 5 are composed of n+4 bits.

Take the case, for example, that 2A and 2u are selected for the values of multipliers B and N in the first operation. In this instance, the operation result S by CSA 6 will be
S=2A[n:0]+2u[n:0].

Then, the number of the digits in the operation result S becomes (n+2 bits) from (n+1 bits)+(n+1 bits). The lowest 2 bits in this operation result S are supplied from CSA 6 and the remaining n bits are stored in CSA 6 to be added in the next operation.

Subsequently, in the next operation, if 2A and 2u are again selected for the values of multipliers B and N, the operation result S by CSA 6 will become
S=2A [n:0]+2u [n:0]+S [n−1:0].

Then, the number of the digits in the operation result S becomes (n+3 bits) from (n+1 bits)+(n+1 bits)+(n bits). The lowest 2 bits in this operation result S are supplied from CSA 6 and the remaining n+1 bits are stored in CSA 6 to be added in the next operation.

Subsequently, in the next operation, if 2A and 2u are again selected for the values of multipliers B and N, the operation result S by CSA 6 will become
S=2A [n:0]+2u [n:0]+S [n:0].

Then, the number of the digits in the operation result S becomes (n+3 bits) from (n+1 bits)+(n+1 bits)+(n+1 bits). The lowest 2 bits of this operation result S are supplied from CSA 6 and the remaining n+1 bits are stored in CSA 6 to be added in the next operation. Similar operations are thereafter repeated: the lowest 2 bits are supplied at the completion of each operation and the remaining n+1 bits are stored in CSA 6 to be employed in the next operation. At this stage of the operation, the number of digits of the operation result S is (n+1 bits)+(n+1 bits)+(n+1 bits), necessarily falling within n+3 bits.

Thus, even when the case of adding 2A and 2u, which are maximum values, is taken into account, the number of digits of the operation result is n+3 bits at maximum. In this regard, taking into account the case of the negative maximum values (−2A, −2u) being repeatedly added, in which a sign bit (1 bit) is required, the number of the digits of the operation result S becomes n+4 bits in total. Thus, the selected values of the multiplicands supplied from first and second logic circuits 4, 5 to CSA 6 are also n+4 bits at maximum to accord with the number of digits operation result S.

CSA 6 computes A×B and u×N individually by shift-adding the values successively supplied from respective logic circuits 4, 5 and provides the added result S as output. CSA 6 provided in the modular-multiplication computing unit of the present invention is supplied with the data of n+4 bits at maximum from first and second logic circuits 4, 5. Hence, the CSA of the invented modular-multiplication computing unit has a processing bit length extended by a bit length corresponding to this bit extension, as compared to the processing bit length of the CSA provided in a conventional modular-multiplication computing unit. CSA 6 is provided with shift registers that store the carry output and added result (sum), respectively, and supplies the operation result in units composed of a plurality of bits (2 bits in FIG. 3) while keeping the interim results using the shift registers. Operation result S provided from CSA 6 is added to the output of first shift register 8 (the computed result of modular-multiplication operation S) in units composed of a plurality of bits and the added result is again stored in first shift register 8.

For reference, first latch circuit 1, second latch circuit 2, first shift register 8 and u-generating unit 10 need not necessarily be provided in the interior of the modular-multiplication computing unit, but can be provided in an information processing unit that employs the modular-multiplication computing unit.

In addition, in the case where memory elements are provided to keep the values of multipliers B and N temporarily, the memory elements need not necessarily be provided in the interior of the modular-multiplication computing unit, but can be provided in an information processing unit that employs the modular-multiplication computing unit. Further, control unit 11 also need not necessarily be provided in the interior of the modular-multiplication computing unit, and can be realized by a processor unit (CPU) provided in an information processing unit that employs the modular-multiplication computing unit. In other words, the modular-multiplication computing unit need be provided with only the constituent elements enclosed by the dotted line shown in FIG. 3.

Furthermore, multiplicands A and u need not necessarily be stored in latch circuits, but any memory elements can be employed if the memory elements are capable of temporarily keeping data, such as shift registers, RAMs, etc.

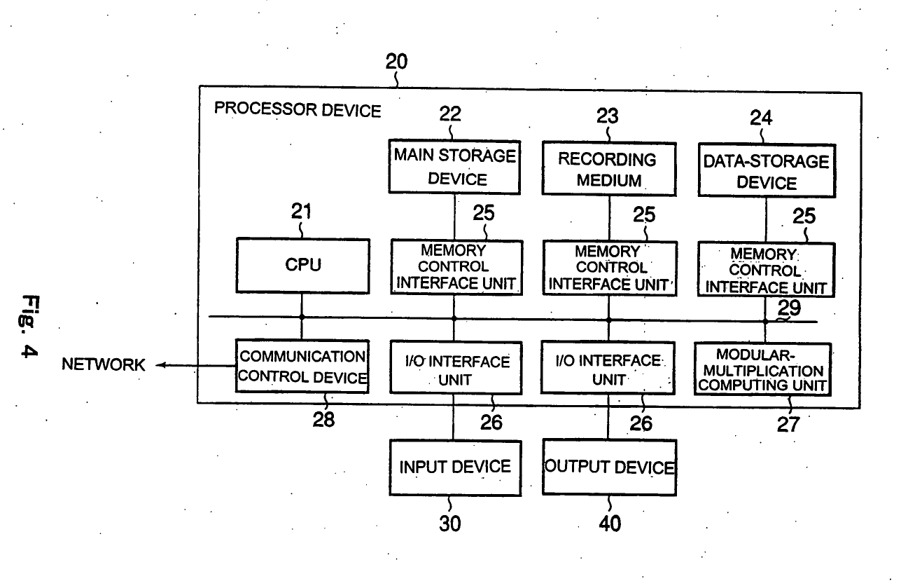

As shown in FIG. 4, the information processing unit of the present invention is, for example, a computer system such as a personal computer, server device or the like and is configured to have processor device 20 adapted for implementing a predetermined process in accordance with a program; input device 30 for supplying commands, information, etc. to processor device 20; and output device 40 for monitoring the result processed by processor device 20.

Processor device 20 comprises: CPU 21; main storage device 22 that temporarily stores the information required for processes to be executed by CPU 21; recording medium 23 that records programs whose processes, that ate imposed on control unit 11, will be executed by CPU21; data-storage device 24 that stores the data etc required for processing; memory control interface units 25 that control data transfers with main storage device 22, recording medium 23 and data-storage device 24; I/O interface units 26 that interface with input device 30 and output device 40; modular-multiplication computing unit 27 shown in FIG. 2; and communication control device 28 that serves as an interface to control the communication between a network etc; wherein the above constituent elements are interconnected by way of a bus 29. For reference, processor device 20 can include latch circuits for keeping multiplicands A and u and shift registers for keeping multipliers B, N and operation result S, etc. depending on the construction of modular-multiplication computing unit 27.

Processor device 20 executes the processes imposed on control unit 11 making use of CPU 21 according to the program loaded in recording medium 23 and performs the calculation of S=S+Aᵢ×B+u×N making use of modular-multiplication computing unit 27. For reference, recording medium 23 can be a magnetic disk, a semiconductor memory, an MO disk or other recording medium.

Specific explanation is next given referring to the drawings regarding the operation of the modular-multiplication computing unit according to the present invention.

In the following description, explanation is given in regard to an example in which A, u, B and N are each prescribed as 512 bits; CSA 6 having a processing bit length of 64 bit is employed; multipliers B and N are supplied to first and second logic circuits 4, 5 on a 3 bit basis; and first shift register 8 receives and supplies modular-multiplication operation result S on a 2 bit basis. Further, it is required that multiplicands A and u be store in first and second latch circuits 1, and 2 respectively, on a 64 bit basis to accord with the processing bit length of CAS 6.

In the case of supplying multipliers B and N on a 3 bit basis making use of CAS 6 of a 64 bits processing bit length, the modular-multiplication operation (512 bits×512 bits×2⁻⁵¹² mode 512 bits) using A, u, B and N of 512 bits each can be achieved by repeatedly carrying out operations of 64 bits×512 bits×2⁻⁶⁴ mode 512 bits (A×B×2⁻⁶⁴ mode N).

The modular-multiplication computing unit of the present invention takes advantage of the feature in the modular-multiplication operation according to the Montgomery method in which the lowest bits are 0 (in the present case, the lowest 64 bits are 0 H) and calculates in advance the value of u corresponding to the values of the above-described S, A, B and N. The calculated results are stored in u-generating unit 10 in a table format.

For example, if the multipliers are supplied on a 2 bit (exclusive of 1 bit multiples) basis, then the values of u are obtained as follows (wherein N is an odd integer):
if N[1:0]=01 and (S+AiB)[1:0]=00,
then u[1:0]=00 for S=S+AiB+uN=00,
if N[1:0]=01 and (S+AiB)[1:0]=01,
then u[1:0]=11 for S=S+AiB+uN=00,
if N[1:0]=01 and (S+AiB)[1:0]=10,
then u[1:0]=10 for S=S+AiB+uN=00,
if N[1:0]=01 and (S+AiB)[1:0]=11,
then u[1:0]=01 for S=S+AiB+uN=00,
if N[1:0]=11 and (S+AiB)[1:0]=00,
then u[1:0]=00 for S=S+AiB+uN=00,
if N[1:0]=11 and (S+AiB)[1:0]=01,
then u[1:0]=01 for S=S+AiB+uN=00,
if N[1:0]=11 and (S+AiB)[1:0]=10,
then u[1:0]=10 for S=S+AiB+uN=00, and
if N[1:0]=11 and (S+AiB)[1:0]=11,
then u[1:0]=11 for S=S+AiB+uN=00.

Summary of the above table reveals the following:

TABLE 2

| N[1] | S + AiB[1:0] | u |
|---|---|---|
| 0 | 00 | 00 |
| 0 | 01 | 11 |
| 0 | 10 | 10 |
| 0 | 11 | 01 |
| 1 | 00 | 00 |
| 1 | 01 | 01 |
| 1 | 10 | 10 |
| 1 | 11 | 11 |

Here, A, B and N are all known values and S is also a known value because 0 H (at the initiation time of the operation) or the preceding operation result of 64 bits×512 bits×2@ mode 512 bits is used for S. For reference, N is an odd number and consequently fixed to N[1:0]=01 or 11. Then, the values of multiplicand u calculated on the basis of the values of A, B and S are stored in a table format in advance in u-generating unit 10, and control unit 11 decides on the value of multiplicand u by consulting the table.

In the modular-multiplication computing unit of the present invention, control unit 11 sets the lowest 64 bit data of multiplicand A (512 bits) first in first latch circuit 1, supplies the data of multiplier B (512 bits) to first logic circuit 4 and supplies the data of multiplier N (512 bits) to second logic circuit 5.

Subsequently, control unit 11 determines the value of u (for 64 bits) by consulting the table stored in u-generating unit 10 on the basis of 64 bit multiplicand A, 64 bit multiplier B and 64 bit multiplier N and stores the determined value of u in second latch circuit 2.

After setting the multiplicands or multipliers in first and second latch circuits 1, 2, and in first and second logic circuits 4, 5 under control of control unit 11, the modular-multiplication computing unit starts computing S=S+A×B+u×N.

The modular-multiplication computing unit first implements, in first logic circuit 4, the conversion of 3 bit multiplier B using Booth's algorithm, selects one of 0, +1A (64+4 bits), −1A (64+4 bits), +2A (64+4 bits) or −2A (64+4 bits) corresponding to the converted value, and supplies the selected value to CSA 6. Similarly, the modular-multiplication computing unit implements, in second logic circuit 5, the conversion of 3 bit multiplier N using Booth's algorithm, selects one of 0, +1 u (64+4 bits), −1u (64+4 bits), +2u (64+4 bits) or −2u (64+4 bits) corresponding to the converted value, and supplies the selected value to CSA 6.

CAS 6 computes A×B and u×N by performing addition-with-carry operations of the values successively supplied from first and second logic circuits 4, 5, respectively, and supplies the added result (modular-multiplication operation result) S on a 2 bit basis. The operation result provided from CAS 6 is added to the output of first shift register 8 on a 2 bit basis at adder 9 and the added value is stored again in first shift register 8. Repetitively executing these procedures for the entire bit data leads to completion of the operation of 64 bits×512 bits×2^{31 64} mod 512 bits. In this operation step, however, upper 64 bits of the operation result of partial products remain in CAS 6. Thus, the remaining data is stored in first shift register 8 pursuant to the instructions of control unit 11. Consequently, the operation result S of 64 bits×512 bits×2⁻⁶⁴ mod 512 bits is stored in first shift register 8.

When completing the operation of 64 bits×512 bits×2⁶⁴ mod 512 bits, the modular-multiplication computing unit sets the next lowest 64-bit data (the data from the 65th bit to the 128th bit counted from the lowest bit) of multiplicand A into first latch circuit 1 controlled by control unit 11. Further, the modular-multiplication computing unit, as in the above case, obtains the value of multiplicand u by consulting the table in u-generating unit 10, stores the obtained value in second latch circuit 2 and then again starts the operation of 64 bits×512 bits×2⁻⁶⁴ mod 512 bits.

Thereafter, same procedures are repetitively executed on the entire bit data of multiplicand A (512 bits) stored in first latch circuit 1, i.e., the operation of the above 64 bits×512 bits×2⁻⁶⁴ mod 512 bits is repeated 8 times. Thus, the modular-multiplication computing unit completes the computation of 512 bits×512 bits×2⁻⁵¹² mod 512 bits.

Explanation is next presented regarding the technical merits of the modular-multiplication computing unit of the present invention with reference to drawings.

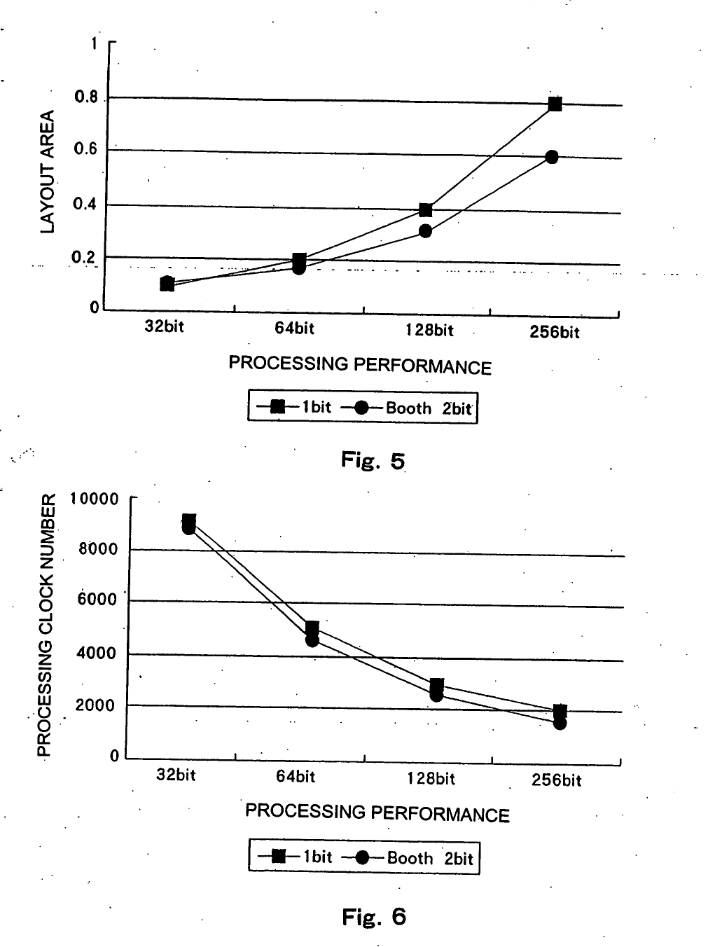

FIG. 5 is a graph representing the layout area of the conventional modular-multiplication computing unit, which supplies a multiplier on a 1 bit basis, and the layout area of the modular-multiplication computing unit according to the present invention which employs the Booth's algorithm. FIG. 6 is a graph representing the processing clock number of the conventional modular-multiplication computing unit, which supplies a multiplier on a 1 bit basis and the processing clock number of the modular-multiplication computing unit according to the present invention which employs the Booth's algorithm.

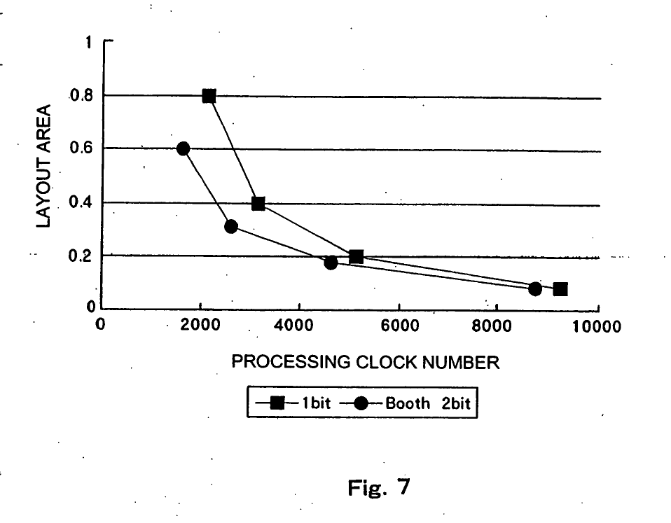

FIG. 7 is a graph represeriting the layout areas, each plotted against the processing clock number, of the conventional modular multiplication computing unit, which supplies a multiplier on a 1 bit basis, and the modular-multiplication computing unit according to the present invention which employs the Booth's algorithm.

The symbol “1 bit” represented in FIGS. 5 and 6 refers to the configuration of the conventional modular-multiplication computing unit that supplies the multipliers on a 1 bit basis, and “Booth 2 bit” refers to the configuration of the modular-multiplication computing unit of the present invention that employs the multipliers converted by Booth's algorithm (radix 4). In addition, the abscissas of the graphs (processing performances) shown in FIGS. 5 and 6 represent the processing bit lengths of the respective CSAs provided in the conventional modular-multiplication computing unit and the modular-multiplication computing unit of the present invention, corresponding to the processing bit lengths (32 bits, 64 bits, 128 bits and 256 bits) of the modular-multiplication computing unit, as shown in FIG. 3. Because the modular-multiplication computing unit in this embodiment multiplies a multiplier by a multiplicand in units of 2 bits, comparison of the processing performances is made by setting the processing bit length of the CSA of the present invention to one half that of the conventional modular-multiplication computing unit that multiplies a multiplier by a multiplicand in units of 1 bit, as shown in FIG. 3. For reference, each entry of Table 3 represents (processing bit length of CAS)×(output bit number).

TABLE 3

| | | Processing performance | | | |
|---|---|---|---|---|---|
| | | 32 bits | 64 bits | 128 bits | 256 bits |
| Configuration | 1 bit | 32 bits × 1 bit | 64 bits × 1 bit | 128 bits × 1 bit | 256 bits × 1 bit |
| | Booth | 16 bits × 2 bits | 32 bits × 2 bits | 64 bits × 2 bits | 128 bits × 2 bits |

FIG. 5 shows that, if the processing bit lengths of a modular-multiplication computing unit are the same, the modular-multiplication computing unit of the present invention, which enables processing a multiplier on a plurality-of-bit basis, has a reduced layout area as compared to the conventional modular-multiplication computing unit, which processes a multiplier on a 1-bit basis. This is because the Booth 2-bit configuration makes it possible to configure the processing bit length of CAS 6 to be one half that of the conventional unit For example, assume that the processing bit length of a modular-multiplication computing unit is 128 bits. Then, the conventional modular-multiplication computing unit will require keeping 128 values for each addition result (SUM) and carry (CARRY) achieved by the CSA and thus necessitates 256 flip-flops (Data F/F).

In contrast, CAS 6 provided in the modular-multiplication computing unit according to the present invention that adopts the Booth 2-bit algorithm needs a processing bit length of only 64 bits, one half that of the conventional technology. As a result, the number of flip-flops needs for keeping the value of addition result (sum) and the value of carry is only 128. More specifically, processing a multiplier in units composed of a plurality of bits through the adoption of Booth's algorithm makes it possible to significantly reduce the number of flip-flops provided in CAS 6, entailing reduction of the circuit size. Furthermore, the reduction of processing bit length of CSA 6 entails reduction of the bit lengths of the first and second latch circuits and logic circuits (corresponds to a selector in the conventional configuration), resulting in reduction of the circuit size associated with the modular-multiplication computing unit. In this regard, the adoption of Booth's algorithm requires extension of the processing bit length of the CSA (4 bits when the radix is 4) and moreover, an increase in the circuit size takes place due to the use of first and second logic circuits 4 and 5. For this reason, the layout area of the modular-multiplication computing unit of the present invention becomes larger than one half that of the conventional modular-multiplication computing unit.

On the other hand, provided that the processing bit length of a modular-multiplication computing unit is the same, the processing clock number is lower in the modular-multiplication computing unit of the present invention which supplies a multiplier on a plurality-of-bit basis, than in the conventional modular-multiplication computing unit which supplies a multiplier on a 1-bit basis, as shown in FIG. 6. This originates from the difference in the processing times to provide as output the operation results of the partial products still remaining in CAS 6 described above.

In the modular-multiplication computing unit of the present invention, while the processing bit length of CAS 6 is made one half that of the conventional modular-multiplication computing unit as described above (in the case of the radix=4), the step in which the multiplicand is divided and processed is required, and thus the modular-multiplication operation need be repeated many times. As a result, in the modular-multiplication computing unit of the present invention, the number of repetitions in the repetitive operation is increased as compared to that in the conventional modular-multiplication computing unit, and the number of output times for the operation results of partial products remaining in CAS 6 is also increased.

In the modular-multiplication computing unit of the present invention, however, the processing bit length in CAS 6 can be reduced so that the processing time that is needed to provide the operation result remaining in CAS also becomes one half the processing time needed in the conventional modular-multiplication computing unit (in the case of radix=4). For this reason, the processing time of one modular-multiplication operation for A, u, B and N is reduced as compared to the conventional case, but the reduction is only slight.

Although the modular-multiplication computing unit of the present invention is incapable of realizing a significant reduction of the processing time, even the slight improvement in the processing time can be greatly advantageous if the modular-multiplication computing unit of the present invention is employed to encrypt and decrypt the RSA cryptography, in which modular exponentiation operations of large values for a string of a multitude of numerics are executed.

FIG. 7 shows that the modular-multiplication computing unit of the present invention, which employs Booth's algorithm, has a small circuit size and enables realization of high speed processing as compared to the conventional modular-multiplication computing unit, which provides a multiplier in units of 1 bit.

For reference, Table 4 and Table 5 shows the increases in the circuit size of the modular-multiplication computing unit of the present invention, to which Booth's algorithm is applied, in cases when the radix number is increased. The modular-multiplication computing unit of the present invention implements the processing of multipliers B and N on a 4 bit basis in cases when the radix 4 so that the processing performance attains 4 times that of the conventional modular-multiplication computing unit, provided that the bit widths of CSAs 6 in both computing units are the same. For reference, the unit of the numerics for the entries in Table 4 and Table 5 is mm².

TABLE 4

Booth's algorithm

| Processing | Prior art | Radix 4 | Radix 16 |
|---|---|---|---|
| performance | (1 bit basis) | (2 bit basis) | (4 bit basis) |
| 64 bits | 0.292 | 0.241 | 0.224 |
| 128 bits | 0.580 | 0.403 | 0.393 |
| 256 bits | 1.153 | 0.778 | 0.741 |

As shown in Table 4, the modular-multiplication computing units according to the present invention, which adopt the Booth's algorithm, are configured using basically the same circuit sizes for both radix 4 and radix 16, and exhibit about 30% reduction in the layout area in comparison with the conventional modular-multiplication computing unit.

TABLE 5

Booth's algorithm

| | | | |
|---|---|---|---|
| Bit length of | Prior art | Radix 4 | Radix 16 |
| CSA | (1 bit basis) | (2 bit basis) | (4 bit basis) |

| | | | | |
|---|---|---|---|---|
| 16 | bit | 0.076 | 0.117 | 0.224 |
| 32 | bit | 0.148 | 0.241 | 0.393 |
| 64 | bits | 0.292 | 0.403 | 0.741 |
| 128 | bits | 0.580 | 0.778 | 1.463 |
| 256 | bits | 1.153 | 1.529 | 2.894 |

As shown in Table 5, in the case of radix 4, while the processing speed is twice in the modular-multiplication computing unit of the present invention, which adopts the Booth's algorithm, as compared to the conventional modular-multiplication computing unit, the layout area only needs about 1.3 times the area of the prior art. Further, in the case of radix 16, while the processing speed is about 4 times, the layout area only needs about 2.6 times the area of the prior art.

Now, assuming that the output bit number of multipliers B and N is q, multiplicand u can be calculated using the equations below based on the algorithm (1), (5) obtained by applying the above-described Montgomery method.
v=−N⁻¹ mod 2^{-q}, and
u=Sv mod 2^{q},
where v is calculated one time only at the startup of the computation. For reference, the reason for putting 2^{q} in place of r is that r is expressed as a binary number.

In the case of the conventional modular-multiplication computing unit, in which q=1, v=1 because N is an odd number, u=S mod 2=S[0], therefore, multiplicand u becomes equal to the lowest bit of S. For this reason, it is not necessary to actually calculate multiplicand u.

However, in the modular-multiplication computing unit of the present invention, in which q>1, u=S[0] will not apply. Thus, the above two operations have to be made. In this regard, in the case where the value of q is small (for example q=2, or 4), v and u are also of 2 bits or 4 bits, and N and S, which are necessary for the operations, are also of 2 bits or 4 bits. Allowing for this fact, the present invention pre-computes the value of u from the values of A, B, S and N to make a table, referring to which the value of u needs to be stored in second latch circuit 2.

Increasing the value of q by making a radix for the Booth conversion of a multiplier larger enables further reducing the processing bit length of CSA 6, enabling in turn a reduction in the processing time of a modular-multiplication operation.

Because a decoder etc is necessary for selecting multiplicand u from the entry in the table, the circuit size will increase in cases where q>4, i.e., in the configuration of supplying multipliers B and N in a 8-bit or more batch (the radix being 64 or more). Consequently, the circuit size of u-generating unit 10, including a memory element increases, canceling the advantage of the reduction effect in the circuit size of the modular-multiplication computing unit, which results from the reduction in the processing bit length in CAS 6, as described above.

Table 6 represents a layout area (unit: mm²) of u-generating unit 10 for q values, and Table 7 represents the total layout area (unit: mm²) including the CAS and u-generating unit for q values.

TABLE 6

| q = 1 | q = 2 | q = 3 | q = 4 |
|---|---|---|---|
| 0 | 0.003 | 0.014 | 0.937 |

TABLE 7

| CSA + u- | | | | | |
|---|---|---|---|---|---|
| generating unit | | q = 1 | q = 2 | q = 3 | q = 4 |
| 32 | bits | 0.103 | 0.169 | 0.308 | 1.371 |
| 64 | bits | 0.292 | 0.423 | 0.529 | 1.903 |
| 128 | bits | 0.580 | 0.842 | 1.171 | 2.988 |
| 256 | bits | 1.153 | 1.691 | 2.310 | 5.135 |

Table 6 and Table 7 show that, compared to the total layout area in the case of q=1 where the processing bit length of a CAS is designed to be, for example, 256 bits, the total layout area decreases in the case of q=2 (the radix being 4) where the processing bit length of a CAS can be designed to be 128 bits, and also in the case of q=4 (the radix being 16) where the processing bit length of a CAS can be designed to be 64 bits. If q=8 (the radix being 64), however, the total layout area increases.

Thus, it is desirable for the modular-multiplication computing unit of the present invention that the value of q is 2 or 4 in order to reduce the processing time while preventing an increase in the circuit size. In this regard, if the purpose is to give preference to improvement of the processing time over the circuit size, however, it is permissible to set the value of q to be 8 or more. In such a case, selecting an optimal value of q taking into account an increase in the layout area of u-generating unit 10 is recommended.

While a preferred embodiment of the present invention has been described using specific terms, such description is for illustrative purposes only, and it is to be understood that changes and variations may be made without departing from the spirit or scope of the following claims.

What is claimed is:

1. A modular-multiplication computing unit for computing S=S+A×B+u×N wherein A and u denote multiplicands, B and N denote multipliers and S denotes a result of modular-multiplication operation, comprising:
a first logic circuit that supplies the value of an integral multiple of said multiplicand A corresponding to a multiplication result of said multiplicand A and the value of the multiplier B that has been converted using Booth's algorithm and is externally supplied in units composed of a plurality of bits q;
a second logic circuit that supplies the value of an integral multiple of said multiplicand u corresponding to a multiplication result of said multiplicand u and the value of the multiplier N that has been converted using Booth's algorithm and is externally supplied in units composed of a plurality of bits q;
a carry save adder that performs an operation of A×B+u×N through the use of the values successively supplied from said first and second logic circuits and supplies the operation result in units composed of said number of bits q; and
an adder that adds the operation result of said A×B+u×N supplied from said carry save adder and the operation result of said A×B+u×N in the past externally supplied in units of said number of bits q, and supplies the added result as said result of modular-multiplication operation S.

2. The modular-multiplication computing unit according to claim 1, further comprising:
a first memory element that keeps externally supplied said multiplicand A and supplies it to said first logic circuit,
a second memory element that keeps externally supplied said multiplicand u and supplies it to said second logic circuit, and
a third memory element that keeps said result of modular-multiplication operation S supplied from said adder and supplies the result of modular-multiplication operation S, which has been kept, to said adder in units composed of said number of bits q in the order in which the result of modular-multiplication operation S has been kept.

3. The modular-multiplication computing unit according to claim 2, further comprising:
a control unit that converts said multiplier B through the use of said Booth's algorithm and supplies the converted value to said first logic circuit, and also converts said multiplier N through the use of said Booth's algorithm and supplies the converted value to said second logic circuit.

4. The modular-multiplication computing unit according to claim 3, wherein said control unit sets multiplicand A to said first memory element and sets multiplicand u to said second memory element.

5. The modular-multiplication computing unit according to claim 4, further comprising:
a u-generating unit that stores the values of said multiplicand u corresponding to precomputed said multiplicand A, said multiplier B, said multiplier N and said result of modular-multiplication operation S, wherein said control unit determines the value of said multiplicand u to be set in said second memory element by referring to said u-generating unit.

6. The modular-multiplication computing unit according to claim 1, wherein the number of bits q is 2.

7. The modular-multiplication computing unit according to claim 1, wherein the number of bits q is 4.

8. A modular-multiplication computing unit for computing S=S+A×B+u×N wherein A and u denote multiplicands, B and N denote multipliers and S denotes a result of a modular-multiplication operation, comprising:
a first logic circuit that converts the bit strings of said multiplier B externally supplied in units composed of a plurality of bits q+1 through the use of Booth's algorithm and supplies the value of an integral multiple of said multiplicand A corresponding to a multiplication result of the converted value and said multiplicand A;
a second logic circuit that converts the bit strings of said multiplier N externally supplied in units composed of a plurality of bits q+1 through the use of Booth's algorithm and supplies the value of an integral multiple of said multiplicand u corresponding to a multiplication result of the converted value and said multiplicand u;
a carry save adder that performs an operation of A×B+u×N through the use of the values successively supplied from said first and second logic circuits and supplies the operation result in units composed of said number of bits q; and
an adder that adds the operation result of said A×B+u×N supplied from said carry save adder and the operation result of said A×B+u×N, in the past externally supplied in units composed of said number of bits q, and supplies the added result as said result of modular-multiplication operation S.

9. The modular-multiplication computing unit according to claim 8, further comprising:
a first memory element that keeps externally supplied said multiplicand A and supplies it to said first logic circuit,
a second memory element that keeps externally supplied said multiplicand u and supplies it to said second logic circuit, and
a third memory element that keeps said result of modular-multiplication operation S supplied from said adder and supplies the result of modular-multiplication operation S, which has been kept, to said adder in units composed of said number of bits q in the order in which the result of modular-multiplication operation S has been kept.

10. The modular-multiplication computing unit according to claim 9, further comprising:
a control unit that sets multiplicand A to said first memory element and set multiplicand u to said second memory element and also operates to supplies said multiplier B to said first logic circuit and said multiplier N to said second logic circuit.

11. The modular-multiplication computing unit according to claim 10, further comprising:
a u-generating unit that stores the values of said multiplicand u corresponding to precomputed said multiplicand A, said multiplier B, said multiplier N and said result of modular-multiplication operation S, wherein said control unit determines the value of said multiplicand u to be set in said second memory element by referring to said u-generating unit.

12. The modular-multiplication computing unit according to claim 8, wherein the number of bits q is 2.

13. The modular-multiplication computing unit according to claim 8, wherein the number of bits q is 4.

14. An information processing unit, comprising:
a modular-multiplication computing unit according to claim 1,
a first memory element that keeps said multiplicand A and supplies it to said first logic circuit,
a second memory element that keeps said multiplicand u and supplies it to said second logic circuit,
a third memory element that keeps.said result of modular-multiplication operation S supplied from said adder and supplies the result of modular-multiplication operation S, which has been kept, to said adder in units composed of said number of bits q in the order in which the result of modular-multiplication operation S has been kept.

15. The information processing unit according to claim 14, further comprising:
a control unit that converts said multiplier B through the use of said Booth's algorithm and supplies the converted value to said first logic circuit, and also converts said multiplier N through the use of said Booth's algorithm and supplies the converted value to said second logic circuit.

16. The information processing unit according to claim 15, wherein said control unit sets multiplicand A to said first memory element and sets multiplicand u to said second memory element.

17. The information processing unit according to claim 16, further comprising:
a u-generating unit that stores the values of said multiplicand u corresponding to precomputed said multiplicand A, said multiplier B, said multiplier N and said result of modular-multiplication operation S, wherein said control unit determines the value of said multiplicand u to be set in said second memory element by referring to said u-generating unit.

18. The information processing unit according to claim 14, wherein the number of bits q is 2.

19. the information processing unit according to claim 14, wherein the number of bits q is 4.

20. An information processing unit, comprising:
a modular-multiplication computing unit according to claim 8, a first memory element that keeps said multiplicand A and supplies it to said first logic circuit,
a second memory element that keeps said multiplicand u and supplies it to said second logic circuit,
a third memory element that keeps said result of modular-multiplication operation S supplied from said adder and supplies the result of modular-multiplication operation S, which has been kept, to said adder in units composed of said number of bits q in the order in which the result of modular-multiplication operation S has been kept.

21. The information processing unit according to claim 20, further comprising:
a control unit that sets multiplicand A to said first memory element and sets multiplicand u to said second memory element and also supplies said multiplier B to said first logic circuit and supplies said multiplier N to said second logic circuit.

22. The information processing unit according to claim 21, further comprising:
a u-generating unit that stores the values of said multiplicand u corresponding to precomputed said multiplicand A, said multiplier B, said multiplier N and said result of modular-multiplication operation S, wherein said control unit determines the value of said multiplicand u to be set in said second memory element by referring to said u-generating unit.

23. The information processing unit according to claim 20, wherein the number of bits q is 2.

24. The information processing unit according to claim 20, wherein the number of bits q is 4.
